(19) United States
(12) Patent Application Publication
(10) Pub. No.: US 2007/0078690 A1
(43) Pub. Date: Apr. 5, 2007

(54) Survivor benefit plan, method and computer program product for providing a survivor income-replacement plan that is adjusted for inflation

(75) Inventor: Rex L. Kohl, Eden Prairie, MN (US)

Correspondence Address: ALTERA LAW GROUP, LLC, 6500 CITY WEST PARKWAY, SUITE 100, MINNEAPOLIS, MN, 55344-7704, US

(73) Assignee: Associated Financial Group

(21) Appl. No.: 11/242,287

(22) Filed: Oct. 3, 2005

(51) Int. Cl. G06Q 40/00

(52) U.S. Cl. 705/4; 705/35

(57) ABSTRACT

A method and computer program product for providing survivor income-replacement benefits having a guaranteed rate of interest with the possibility of a higher income stream to the designated survivor if supported by prevailing interest rates at the time of annuitization. In one embodiment, the insured would purchase either a fixed level dollar amount of monthly income for a fixed period of time or a Cost of Living Adjusted (COLA) benefit in the form of a monthly annuity. The insurance carrier is required to contractually guarantee a minimum rate of interest, e.g., 3% at the time of annuitization. The insurance carrier is further required to apply the same discount rate to the annuity contract that is provided to the best commercially available immediate annuity contract the carrier offers at the time of annuitization, subject to the minimum guaranteed rate of interest. Thus, the beneficiary may receive an increased income stream if the relevant interest rate at the time of the purchaser's death exceeds the guaranteed minimum interest rate. Thus, if the insured purchased a survivor benefit under the inventive method with a 3% guaranteed minimum COLA, and if the best commercially available immediate annuity interest rate is 6%, the benefit paid the beneficiary survivor is increased annually at a rate of 6%. Without COLA, the contract simply starts paying higher level monthly benefits based on the higher 6% discount rate.

### CROSS-REFERENCE TO RELATED APPLICATIONS

None

### BACKGROUND OF THE INVENTION

1. Field of the Invention

The present invention is directed to a survivor benefit plan, method and computer program product for providing a survivor benefit income-replacement plan having a minimum guaranteed rate of interest and a built-in regulator to provide an adjustment based on prevailing interest rates at the time of death of the benefit purchaser.

2. Description of the Related Art

Known survivor benefit plans are generally employee benefits, sponsored by the employer and which provide the employee's designated and surviving beneficiary with a predetermined and periodic income stream when the employee dies.

Individual employees are also currently able to purchase their own survivor benefit plans. A major disadvantage to this type of plan includes increased cost as compared with the employer-sponsored group plan. Thus, it is cost inefficient for most individuals to purchase their own survivor benefit plan.

Known survivor benefit plans comprise insurance-based funding. In such plans, the employer, in a group employer-sponsored plan, contracts with an insurance company to administer and provide the survivor benefit. The insurance company may be provided with employee demographic data. Based on these data, as well as other information, the insurance company calculates the estimated plan liabilities, computes a premium value for the employees (or the employer). The insurance company also typically includes a profit margin to compensate for the risk involved.

The insurance industry has focused on the marketing of supplemental group life insurance in the form of lump sum death benefits for some time. Purchasing death benefits in lump sums is appropriate for lump sum needs such as debt elimination, but often the most pressing need for death benefits purchased by employees is income replacement.

Typical survivor benefit income replacement contracts provide a fixed monthly income as a percentage of pre-death income for a specified period of time. Alternatively, the fixed monthly income may be paid to a specified survivor's age. Certain currently available programs provide a Cost of Living Adjustment (COLA) benefit at a fixed rate, e.g., 3% to adjust for the effects of inflation.

In these known types of survivor benefit income replacement contracts, the insured, at time of application, would purchase either a specified dollar amount of monthly income for a specified period of time or a COLA adjusted benefit. This would be accomplished through the irrevocable election of a death benefit payout in the form of a monthly annuity for the time period specified at the time of application.

Most currently available annuity contracts will have a minimum guaranteed rate of interest, e.g., of 3%. In this case, for the purchaser of a fixed benefit for a fixed period of time, the amount of death benefit required to fund the survivor benefit is the sum of the monthly benefits payable discounted by the exemplary guaranteed 3%. For the purchaser electing the COLA option, the death benefit required would be the first monthly payment multiplied by the number of months the benefit is to be paid. The exemplary 3% guaranteed interest rate on the annuity contract covers the 3% COLA adjustment in this case.

Given the currently available survivor benefit packages, it would be desirable to provide a survivor income replacement option that provides more accurate inflation protection than COLA by providing additional income to the survivor should the prevailing interest rates at the time of death be higher than that guaranteed at the time of purchase.

### BRIEF SUMMARY OF THE INVENTION

A method and computer program product for providing survivor income-replacement benefits having a guaranteed rate of interest with the possibility of a higher income stream to the designated survivor if supported by prevailing interest rates at the time of annuitization. In one embodiment, the insured would purchase either a fixed level dollar amount of monthly income for a fixed period of time or a Cost of Living Adjusted (COLA) benefit in the form of a monthly annuity. The insurance carrier is required to contractually guarantee a minimum rate of interest, e.g., 3% at the time of annuitization. The insurance carrier is further required to apply the same discount rate to the annuity contract that is provided to the best commercially available immediate annuity contract the carrier offers at the time of annuitization, subject to the minimum guaranteed rate of interest. Thus, the beneficiary may receive an increased income stream if the relevant interest rate at the time of the purchaser's death exceeds the guaranteed minimum interest rate. Thus, if the insured purchased a survivor benefit under the inventive method with a 3% guaranteed minimum COLA, and if the best commercially available immediate annuity interest rate is 6%, the benefit paid the beneficiary survivor is increased annually at a rate of 6%. Without COLA, the contract simply starts paying higher level monthly benefits based on the higher 6% discount rate.

An object of the invention is to provide a method and computer program product that provides inflation protection to survivor benefits.

Another object of the invention is to provide a method and computer program product that provides inflation protection to survivor benefits at a level above the COLA adjustment when relevant interest rates are higher than the COLA adjustment at conversion.

Another object of the invention is to provide a method and computer program product that provides the survivor's beneficiary with an income stream that is potentially larger than the income stream derived using COLA adjustments alone.

The figures and the detailed description which follow more particularly exemplify these and other embodiments of the invention.

### BRIEF DESCRIPTION OF THE DRAWINGS

The invention may be more completely understood in consideration of the following detailed description of various embodiments of the invention in connection with the accompanying drawings, which are as follows.

FIG. 1 is a flowchart of one embodiment of the invention.

### DETAILED DESCRIPTION OF THE INVENTION, INCLUDING THE BEST MODE

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

A method and computer program product is provided that allows purchasers of survivor death benefits to provide a guaranteed minimum income stream to the beneficiary with the possibility of a larger income stream. Thus, one embodiment of the inventive method provides a guaranteed survivor benefit, either a fixed/level benefit or with a COLA adjustment, in combination with an adjustment to the purchased benefit if the prevailing interest rates, as a mirror of inflation, are higher than the guaranteed rates at the time of conversion, i.e., the purchaser's death.

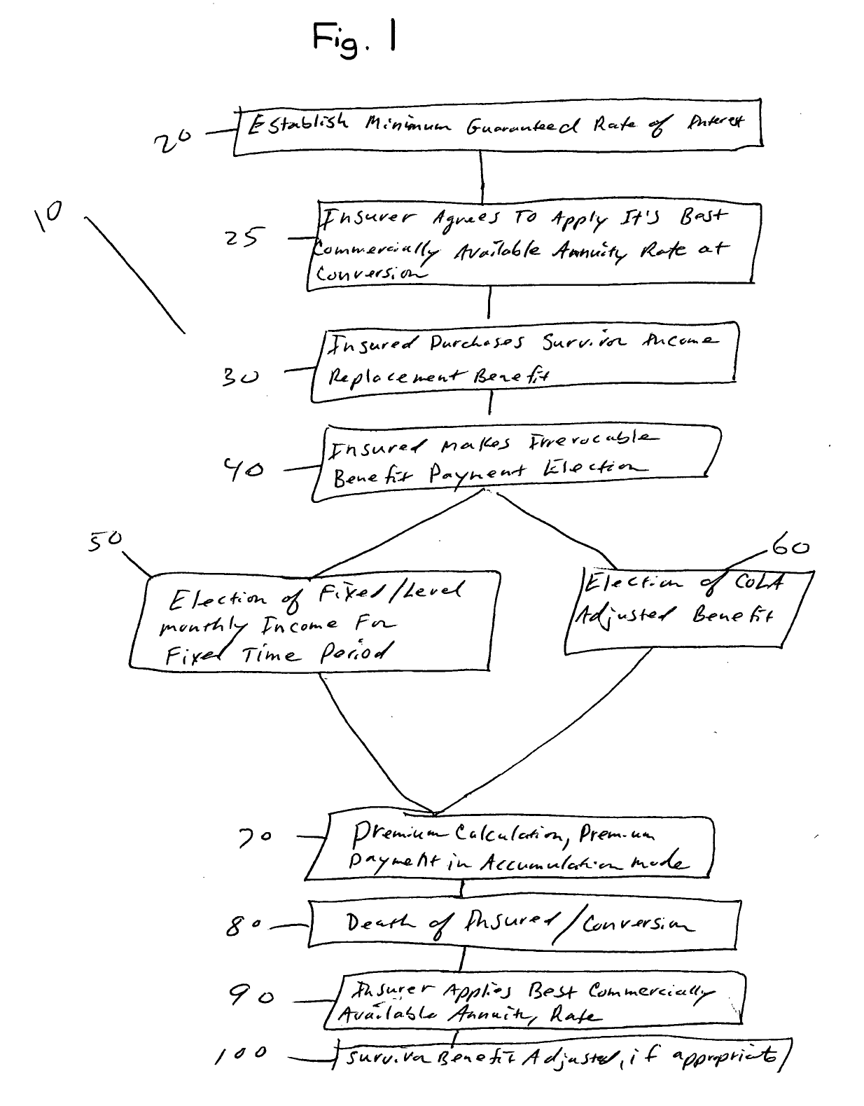

With reference to FIG. 1, one embodiment of a survivor benefit method comprising a guaranteed minimum income stream, with a built-in regulator, or adjustment mechanism is provided (10). Initially, a minimum guaranteed rate of interest is established for application to the survivor benefit (20). In various embodiments, this minimum guaranteed rate of interest may be derived from the minimum guaranteed rate of interest in the current commercially available annuity contracts. Essentially, this minimum guaranteed interest rate (20) is intended to provide a lower threshold of inflation protection. For example, such commercially available annuity contracts may have a minimum guaranteed interest rate of 3%. Alternatively, other indicators to establish the lower threshold of inflation protection may be used, e.g., the prevailing COLA, and may be apparent to those skilled in the art. Such alternative indicators are within the scope of this invention.

The insurance carrier further agrees to determine the interest/discount rate it is applying to its best commercially available immediate annuity contract at the time of the purchaser's death (25). The insurance carrier further agrees to apply this determined interest rate to the purchased survivor benefit annuity upon conversion at the time of the purchaser's death, subject to the minimum guaranteed rate of interest. Thus, the best commercially available annuity interest rate may, e.g., be determined to be 6% at the time of the purchaser's death and conversion. This determined rate of 6% is the rate the carrier will apply at conversion.

The inventive survivor benefit method may then be purchased by an insured (30), for the benefit of a beneficiary upon the insured's death. The insured and/or purchaser must, upon purchase, irrevocably elect a form of benefit payout (40). For example, the insured and/or purchaser may select a fixed/level monthly income stream to be paid to the surviving beneficiary for a fixed period of time (50). Alternatively, the survivor may elect a monthly income stream that is adjusted periodically, generally annually, based on the prevailing Cost of Living Adjustment (COLA) rate (60). Alternative election possibilities may be known to those skilled in the art and are within the scope of this invention.

COLA is defined herein as arising from legislation enacted in 1973 to provide for automatic cost-of-living adjustments, or COLAs in response to inflation. The COLAs prevent inflation from eroding, inter alia, Social Security and Supplemental Security Income benefits. The COLA is calculated as defined within the Social Security Act. Generally, the COLA is equal to the percentage increase in the Consumer Price Index for Urban Wage Earners and Clerical Workers from the third quarter of one year to the third quarter of the next.

Regardless of the election made by the insured and/or purchaser in (40), once the transaction is complete, the carrier underwrites the purchased plan and the insured and/or purchaser begins making premium payments during premium payment mode (70). Because the COLA benefit provides additional income to the survivor over time as compared with the fixed income/fixed period benefit, the COLA benefit premium may be slightly higher.

Upon the death of the purchaser, the survivor benefit converts from premium payment mode to payout mode (80). As discussed above, the carrier determines the interest rate/discount rate that it is providing to its best commercially available annuity contract as of the date of the conversion (90).

Once the proper interest rate to be applied to the annuity is determined, the benefit payment to the survivor may require adjustment. Such adjustment is only made if the determined interest rate determined above in (90) is higher than the minimum guaranteed interest rate established above in (20).

Thus, if the purchaser elected the fixed/level income for a fixed period annuity, any additional interest above that minimally guaranteed will provide a correspondingly higher monthly benefit to the surviving beneficiary for the contracted fixed time period. If the purchaser elected the COLA adjusted benefit, the benefit paid would provide an enhanced monthly payment, including the COLA adjustment, corresponding to the additional interest applied to the annuity.

In this manner, the inventive method comprises a built-in regulator to assist survivors in overcoming the effects of inflation.

The inventive method having been described, it will further be illustrated by way of example.

### EXAMPLE 1

In this example, the insurer guarantees a minimum rate of return of 3% and the following variables apply:

Insured's Age: 35 years old

Insured's Monthly Income Replacement Needs: $1,500

Desired Payment Period to Survivor: 15 years (180 months).

Insured elects to not adjust the monthly survivor income for inflation at 3% a year. In doing so, the insured declines the COLA adjustment and elects the fixed/level benefit.

Thus, the insured, in this example, irrevocably elects a fixed monthly survivor benefit payment of $1,500 for 180 months with a guaranteed minimum rate of return of 3% and without COLA adjustment. The present value, or the amount required to fund the annuity, at the guaranteed 3% rate of return for fixed monthly payments of $1,500 over 180 months is calculated to be $217,750. The premium required to fund this case is calculated to be $29.97 per month using methodology well known to those skilled in the art.

If, at the time of the exemplary insured's death and conversion to payout, the carrier's best commercially available immediate annuity interest rate is equal to or less than 3%, the annuity contract provides a monthly income of $1,500 to the survivor.

However, now let us assume that the carrier is offering a 5% interest rate for its best commercially available immediate annuity at the time of conversion. In this case, application of 5% interest rate to the amount required to fund the annuity at the guaranteed minimum rate of 3%, i.e., $217,750, provides an increased monthly income to the survivor of $1,722 per months over 180 months.

Alternatively, if, e.g., the applicable interest rate is determined at conversion to be 7%, the proceeds would provide a monthly benefit of $1,946 per month for 180 months.

Other embodiments of the present invention may include election of COLA adjustments to the survivor income replacement benefit. As discussed above, this may require increased premiums to cover the anticipated increase in survivor benefits. Additional embodiments may involve election of a fixed benefit payment (or a COLA adjusted payment) to the survivor upon the insured's death until the survivor reaches a specified age. Premiums are calculated in each embodiment according to methods well known in the art.

The present invention as described herein may be practiced manually, i.e., calculating the required values without aid of a computer. Alternatively, the preferred embodiment is practiced using a computer program product, i.e., a computer program comprising computer software code. In this embodiment, the various steps of the method are embodied in software code, readable by a programmable computer. The necessary data, rate tables, calculation formulas and the like may be programmed and/or stored in a random access memory within the computer which is in communication with a processor capable of performing the required calculations. A database may be provided for storage of data. A keyboard for input of data and variables may be provided and a data display, e.g., computer monitor may be provided to view the input, data and/or results.

The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

What is claimed is:

1. A method for providing a survivor benefit income-replacement plan that is adjusted for inflation, with benefits payable after the death of the insured to the plan's beneficiary, comprising:
establishing a minimum guaranteed rate of interest;
calculating the appropriate value for the premiums;
paying premiums during the life of the insured;
converting the plan to an immediate annuity for payout at the time of the insured's death;
determining best commercially available annuity rate at time of plan conversion to payout;
comparing the best commercially available annuity rate with the minimum guaranteed interest rate;
applying the higher interest rate of the best commercially available annuity rate and the minimum guaranteed interest rate; and
paying the resulting survivor income benefit at the applied interest rate.

2. The method of claim 1, further comprising:
making an irrevocable election of benefit payment.

3. The method of claim 2, wherein the election comprises fixed monthly income benefits for a fixed period of time.

4. The method of claim 2, wherein the election comprises fixed monthly income paid to the survivor beneficiary until the beneficiary reaches a specified age.

5. The method of claim 2, wherein the election comprises monthly income benefits for a fixed period of time wherein the monthly benefit is adjusted according to the prevailing Cost of Living Adjustment (COLA).

6. The method of claim 2, wherein the election comprises monthly income benefits paid to the beneficiary until the beneficiary reaches a certain age, wherein the benefits are adjusted according to the prevailing Cost of Living Adjustment (COLA).

7. A computer program product for providing a survivor benefit income-replacement plan that is adjusted for inflation, comprising:
computer code for establishing a minimum guaranteed rate of interest;
computer code for calculating the appropriate value of premiums;
computer code for determining the best commercially available annuity rate at time of plan conversion to payout;
computer code for comparing the best commercially available annuity rate with the minimum guaranteed interest rate;
computer code for applying the best commercially available annuity interest rate if it is greater than the minimum guaranteed interest rate; and
computer code for determining the resulting survivor income benefit at the applied interest rate.

8. The computer program product of claim 7, further comprising:
computer code for calculating the amount of premium when the election is for a fixed monthly benefit for a fixed period of time.

9. The computer program product of claim 8, further comprising:
computer code for calculating the amount of premium when the election is for a fixed monthly benefit payable until the beneficiary reaches a specified age.

10. The computer program product of claim 9, further comprising:
computer code for calculating the amount of premium when the election is for a Cost of Living Adjusted monthly benefit for a fixed period of time.

11. The computer program product of claim 10, further comprising:
computer code for calculating the amount of premium when the election is for a Cost of Living Adjusted monthly benefit until the beneficiary reaches a specified age.

12. A survivor benefit income-replacement plan, comprising:
an insurance carrier to underwrite the plan;
an insured person under the plan;
a surviving beneficiary, entitled to the benefit of the plan upon the death of the insured person;
an irrevocable election of benefits by the insured person;
a minimum guaranteed rate of interest based on inflation rates at the time of purchase of the plan to be applied to the monthly income benefits at the time of the insured person's death; and
a built-in regulator provided by the carrier to ensure that the survivor benefit income provided is at least at the minimum guaranteed rate of interest.

13. The survivor benefit plan of claim 12, further comprising the built-in regulator being the interest rate the carrier applies to its best commercially available immediate annuity at the time of the insured person's death.

14. The survivor benefit plan of claim 13, further comprising the application of the higher of the minimum guaranteed rate of interest and the carrier's best commercially available immediate annuity to ensure the best inflation protection possible.

15. The survivor benefit plan of claim 12, wherein the election is for a fixed monthly income payable to the beneficiary for a fixed period of time.

16. The survivor benefit plan of claim 13, wherein the election further comprises a fixed monthly income payable to the beneficiary until the beneficiary reaches a specified age.

17. The survivor benefit plan of claim 16, wherein the election further comprises a monthly income adjusted for Cost of Living (COLA) payable to the beneficiary for a fixed period of time.

18. The survivor benefit plan of claim 17, wherein the election further comprises a monthly income adjusted for Cost of Living (COLA) payable to the beneficiary until the beneficiary reaches a specified age.
